(19) United States
(12) Patent Application Publication
(10) Pub. No.: US 2006/0106689 A1
(43) Pub. Date: May 18, 2006

(54) Method and apparatus for documenting a contribution of a remotely accessed computing resource to a recipient organization

(75) Inventors: Bret A. Greenstein, Brookfield, CT (US); Daniel A. Powers, Newtown, CT (US); Stephen M. Ward JR., Ridgefield, CT (US)

Correspondence Address: William A. Kinnaman, Jr.;IBM Corporation - MS P386, 2455 South Road, Poughkeepsie, NY, 12601, US

(73) Assignee: International Business Machines Corporation, Armonk, NY (US)

(21) Appl. No.: 10/988,761

(22) Filed: Nov. 15, 2004

(51) Int. Cl. G07F 19/00; G06F 17/22

(52) U.S. Cl. 705/31; 705/30

(57) ABSTRACT

A method and apparatus for documenting for tax purposes a contribution of a remotely accessed computing resource (such as a CPU resource) on a donor system that is allocated by an owner of the resource to one or more recipient organizations. A central management organization (CMO) receives a selection by the owner of the resource of one or more recipient organizations to which to allocate the computing resource, and transmits to the donor system work of the recipient organizations to be performed on the donor system using the allocated computing resource. The CMO receives the results of the work from the donor system and forwards them to the recipient organizations. The CMO records usage of the allocated computing resource on the donor system by each of the recipient organizations and generates a tax receipt documenting the recorded usage of the allocated computing resource on the donor system.

### BACKGROUND OF THE INVENTION

1. Field of the Invention

This invention relates to a method and apparatus for documenting a contribution of a remotely accessed computing resource to a recipient organization.

2. Description of the Related Art

One of the more significant developments in the field of information technology in the last several years has been that of “grid” computing—more particularly, the development of specifications and implementations of “grid” services. Grid service specifications are described in such publications as the following, incorporated herein by reference:
1. Ian Foster et al., “The Physiology of the Grid: An Open Grid Services Architecture for Distributed Systems Integration”, Jun. 22, 2002.
2. Steve Tuecke et al., “Grid Service Specification”, Draft 3, Jul. 17, 2002.

Grid service implementations are available from various organizations. Thus, the Globus Toolkit is an open-source offering available from the Globus Alliance, while the IBM Grid Toolbox is a commercial offering of IBM Corporation that is based in part upon the Globus Toolkit. The underlying concept of grid computing is simple: grid computing allows one to interconnect many individual computers over a network such as the Internet so that they look and act like one large computer.

There have been several motivating factors behind the emergence of grid computing. Chief among them has been the dramatic growth in the number and computing capacity of computers worldwide, much of this capacity remaining unused. Currently there is a vast amount of computing power in the world in the form of both servers and personal computers (PCs). PCs and Internet users continue to grow very quickly. Thus, from 1997 to 2002, the number of Internet users has grown from 95 million users to 650 million users. PC growth has been just as explosive, with the worldwide installed base of PCs (desktop and mobile) expected to grow from 500 million to 850 million between 2000 and 2007.

PCs and computers in general have also become increasingly more powerful. In the next 20 years, the growth of computing power will correspond to hundreds of millions of years of vertebrate evolution. Deep Blue, a computer developed by IBM in 1997 to play chess, had a computing power of 8 teraflops (i.e., 8×10¹² floating-point operations per second), the equivalent processing power of a lizard brain. New supercomputers now being built are in the 50-70 teraflop range. The Advanced Simulation and Computing (ASC) project, formerly the Accelerated Strategic Computing Initiative (ASCI), uses supercomputers built by IBM to analyze and predict the performance, safety, and reliability of nuclear weapons and certify their functionality. These systems are approaching the processing power of a mouse brain.

By 2014 or 2015, a supercomputer (and by 2020, PCs) will have the raw computing power of a human brain. While it is difficult to compare brain operations to computer operations—various types of estimates are used, such as the density of retinal cells extrapolated up to the volume of the brain—it is clear that computers of the future will have enormous capabilities, the uses for which we have only just begun to explore. Special-purpose machines, chess, molecular chemistry computations, and protein folding are among the possibilities.

Storage technology has kept up with and in many cases exceeded what has happened with processing capacity and network bandwidth. The density on disk drives, which determines how much data can be stored, has increased exponentially so that even today, the cost of storage is significantly below the cost of paper. The emergence of new applications, particularly consumer and mobile applications, will continue to put the largest portion of data storage capacity on clients such as PC and “personal-use” devices such as set-top boxes.

As noted above, much of this computing capacity remains unused. Typical PCs are only 2-5% utilized, and servers are only 10-20% utilized. The capacity exists to handle peak demands, but remains unused or underutilized most of the time. Because of this, and because of the recent dramatic growth in network bandwidth, unused central processing units (CPUs) and storage at remote locations represent almost “free” resources to an organization needing additional processing or storage capacity. Grid computing has been developed to provide suitable mechanisms to enable such organizations to discover and negotiate the use of such computing resources.

Grid services have been used to create virtual organizations (VOs) in which available computing resources (processors, storage, etc.) that are actually located remotely appear as local resources to a user. This concept can be applied on a global scale to enable such computers to work on very large computing problems for the benefit of mankind. Thus, this huge pool of fast connected resources could be tapped to deliver tremendous computing and storage capacity for charitable use. In particular, grid computing offers the opportunity for charitable organizations to leverage the collective computing resources owned by individuals, organizations, and companies.

Because of the emergence of this excess computing capacity and the development of grid computing technologies, there is significant computing power which could be donated to be used to support computing needed for charitable causes. Since this can also be done without impact to the primary uses of the “donor” computers, there is little or no downside to this solution.

Grid computing technologies make it possible to interconnect millions of Internet-attached personal computers (PCs) and servers to provide nearly limitless computing and storage capacity. Such grid processing power has been estimated as being four times the size of the world's largest supercomputer and between 10 and 100 times more cost-efficient. This computing capability can be applied to help charitable organizations solve analytical problems, share and analyze data, and to run applications with very low costs for the charity. This could be applied to many types of charities.

There are many examples of charitable computing applications already deployed, including the SETI@home project, directed to the search for extraterrestrial intelligence (SETI), as well as the Smallpox and Cancer Research Projects accessible through the organization grid.org. Today, people participate in grids for such Internet-based projects as SETI@home because those applications interest them. They get no financial incentives to participate.

Recently there have been created incentive models where users are paid to contribute computing capacity, thereby aggregating computing power cost-effectively. U.S. Pat. Nos. 6,725,250 and 6,732,141 (Ellis) thus describe a scheme where personal computer owners provide processing power to a network in exchange for linkage to other computers on the network, with payments being based on a participant's net use or provision of processing power. Similarly, U.S. Patent Publication 2002/0019844 discusses incentives for making commitments of computing time. None of these incentives, however, are particularly workable when the recipient has neither money nor in-kind resources to compensate the donor. What is needed, therefore, is a way to motivate users to donate their computing capacity to these causes.

### SUMMARY OF THE INVENTION

The present invention is based upon the realization that users can be motivated to donate computing resources by anything that benefits them financially, whether or not it comes from the recipient. Where the resource recipient is a charitable organization, that benefit can come in the form of a tax benefit, such as a deduction or credit, depending on the laws of the tax jurisdiction.

The present invention relates to a method and apparatus for documenting for tax purposes a contribution of a remotely accessed computing resource (such as a CPU resource) on a donor system that is allocated by an owner of the resource to one or more recipient organizations. In general, in accordance with the invention, usage of the allocated computing resource on the donor system by the recipient organization is recorded, and a tax receipt is generated documenting the recorded usage of the allocated computing resource on the donor system by the recipient organization.

The present invention thus enables the obtaining of tax benefits for donated computing resources. This is preferably done by leveraging a central management tool that tracks CPU minutes or other donor resources that are used by a grid application. Thus, in a preferred embodiment, a central management organization (CMO) receives a selection by the owner of the resource of one or more recipient organizations to which to allocate the computing resource, and transmits to the donor system work of the recipient organizations to be performed on the donor system using the allocated computing resource. The CMO receives the results of the work from the donor system and forwards them to the recipient organizations. The CMO records usage of the allocated computing resource on the donor system by each of the recipient organizations and generates a tax receipt documenting the recorded usage of the allocated computing resource on the donor system.

The enabling technology on which the present invention is based is currently available from such companies as United Devices, with its Grid MP application, and Entropia, Inc. with its DCGrid application. Each of these applications has components that reside respectively on a central server that parcels out the work and collects the results and on a client that actually performs work it gets from the server and sends it back to the server.

The present invention compiles usage data for each charitable application for each user, analyzes it, then produces and distributes a receipt which can be legally used to claim a tax deduction. Since most PCs are idle over 95% of the time, there is significant unused capacity to donate, and it is reasonable to assume that users may be able to claim up to 95% of the depreciation costs of their PC as having been used for charity. This could dramatically reduce the effective cost of PCs for both individual and corporate users that participate without impacting their ability to use their PCs. It also benefits charities and promotes public awareness of the benefits of grid computing generally.

The value of the present invention to the user is the effective discount off the price of acquisition for the PC. The present invention allows users to receive a financial incentive for participating in a charity, potentially causing them to spend more on their PC purchases. The value to charities is the computing power, which is substantial now and growing constantly, that this invention will encourage users to donate and would have otherwise gone unused.

While in most cases the donated computing resources will be CPU resources, many projects run by charitable organizations will also require large amounts of storage. Storage capacity can be donated in a similar manner to CPU capacity.

The present invention may be implemented as hardware, as software, or as a combination of hardware and software. A software implementation may comprise a program storage device readable by a machine, tangibly embodying a program of instructions executable by the machine to perform the method steps of the invention. A computing infrastructure for performing the method steps of the invention may be deployed by integrating into a computing system computer-readable code that in combination with the computing system is capable of performing the method steps of the invention.

### BRIEF DESCRIPTION OF THE DRAWINGS

FIG. 1 shows a grid computing system incorporating the present invention.

FIG. 2 shows a donor system of the system shown in FIG. 1.

FIG. 3 shows the central management organization of the system shown in FIG. 1.

FIG. 4 shows the information flows between the various components of the system shown in FIG. 1.

FIG. 5 shows the steps performed by the central management organization of the system shown in FIG. 1.

FIG. 6 shows the steps performed by a donor system of the system shown in FIG. 1.

FIG. 7 shows a sample user interface for registration with the central management organization.

FIG. 8 shows an example of the usage tracking performed on the donor system shown in FIG. 1.

### DESCRIPTION OF THE PREFERRED EMBODIMENTS

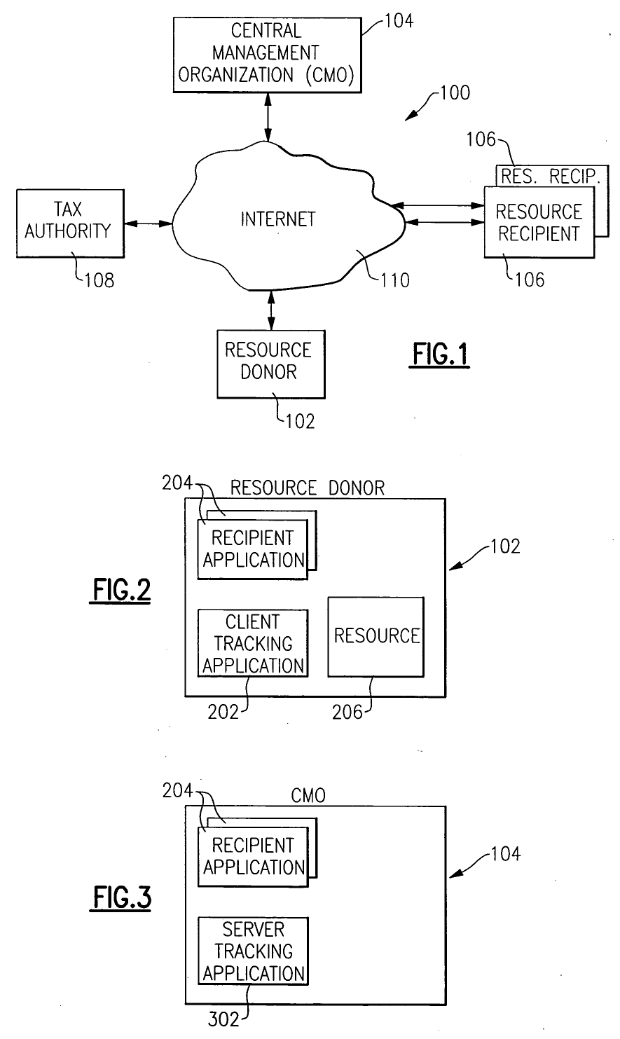

FIG. 1 shows a grid computing system 100 incorporating the present invention. In the system 100, at least one resource donor 102, a least one resource recipient 104, and a central management organization (CMO) 106 are interconnected via a network 108 such as the Internet. Each of the blocks 102-106 depicted in FIG. 1 represents computer resources belonging to the named entity. Although the resources belonging to a particular entity are shown as a single block, those resources (especially those belonging to the recipient 104 and CMO 106) may actually be distributed across the network 108.

More particularly, each resource donor 102 typically comprises a client workstation such as a personal computer (PC) belonging to an individual user and having resources available for use by a recipient. Each resource recipient 104 typically comprises a system belonging to an organization such as an educational institution recognized as a charitable organization under the relevant tax laws of the jurisdictions involved.

CMO 106 typically comprises a server system and intermediates between resource donors 102 and resource recipients 104. As described below, CMO 106 acts as an aggregator, obtaining work from the resource recipients 104 for distribution to the resource donors 102 and collecting results from the resource donors 102 for forwarding back to the resource recipients 104. In addition, CMO 106 tracks the usage by each donor system 102 of its own resources, by means of usage data collected from the donor system 102, and generates a receipt for each such donor system 102, documenting the amount of resources donated by that system. The individual donor can present this receipt to a tax authority (not shown) when claiming a deduction or other favorable tax treatment for the resource donation.

Referring now to FIG. 2, each donor system 102 has running thereon a client tracking application 202 as well as one or more recipient applications 204. Each donor system 102 also has resources 206 that are being donated. Typically, resources 206 represent CPU resources, but may include other resources (such as storage) as well. Tracking application 202 tracks the amount of resources 206 on the donor system 102 that are being used by a particular recipient application 204 running on behalf of a recipient 104. Tracking application 202 is configured to generate usage data for the one or more recipient applications 204, which data is transmitted to CMO 106 as described in more detail below. As noted in the summary portion above, client tracking application 202 may comprise a commercially available application, such as the client component of either Grip MP from United Devices or DCGrid from Entropia.

Each recipient application 204 performs work for a particular recipient 104. The nature of each recipient application 204 depends on the work to be done for the recipient organization and forms no part of the present invention. Each donor system 102 obtains a copy of a recipient application 204 from the CMO 106 when it registers with the CMO and selects the corresponding organization as a recipient for its computing resources, as described below. A donor system 102 may acquire the client tracking application 202 either independently or through the same registration process.

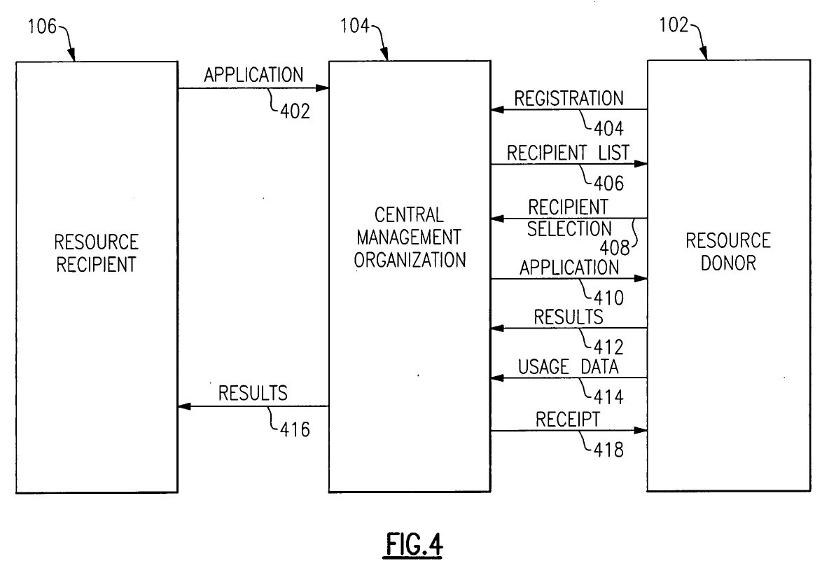

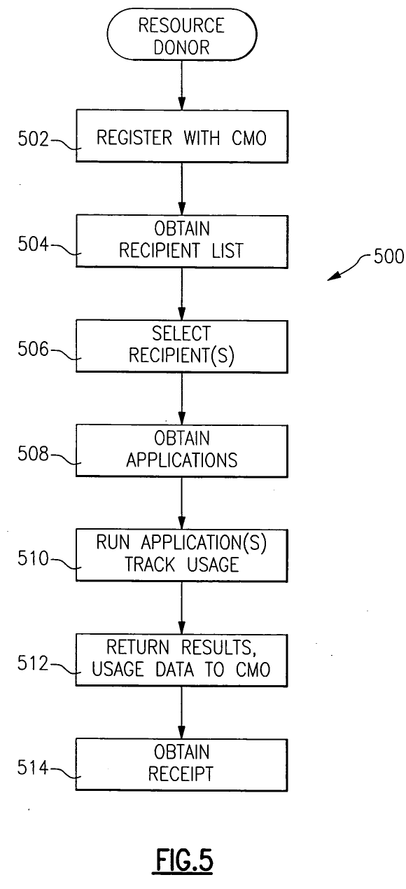

Referring now to FIG. 3, CMO 106 has running thereon a server tracking application 302, which receives usage data from each of the donor systems 102. In a manner similar to that of client tracking application 202, server tracking application 302 may be based upon a commercially available application, such as the server component of either Grid MP from United Devices or DCGrid from Entropia. CMO 106 also stores copies of recipient applications 204 for the various recipients 104 for downloading to a donor system 102. The copies of the applications 204 residing on the CMO 106 are not run on that system, but are only stored for downloading to a donor system 102, where they are run as described below.

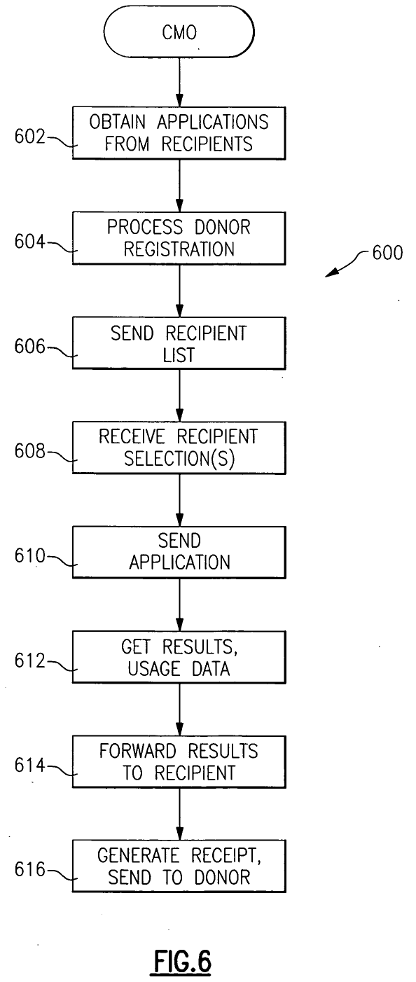

FIG. 4 shows the general data flow between CMO 106 and each donor system 102 and recipient system 104. Although only one of each type of system is shown in FIG. 4, in general grid system 100 will contain multiple donors 102 and recipients 104. The flow starts at step 402, where the CMO 106 obtains an application 204 from recipient system 104, including not only code for performing work on a donor system 102, but also a specification of the work to be done.

The flow then proceeds to a series of interactions between CMO 106 and client system 102. Thus, at step 404, the donor 102 registers with CMO 106, establishing a user ID and password and providing the CMO with whatever identifying information (social security number, taxpayer identification number, etc.) is required by the Internal Revenue Service or other tax authority.

At step 406, CMO 106 provides the donor 102 with a list of recipient organizations 104 to which it can donate computer resources. At step 408, the donor selects one or more recipients 104 to whom it wishes to donate resources, as well as the type and amount of resources to be donated (percentage of CPU time, storage capacity, network bandwidth, etc.). At step 410, CMO provides donor 102 with a copy of a recipient application 204, which the donor system 102 runs using its donated resources 206, with client tracking application 202 simultaneously generating usage data. Donor system 102 may also acquire the client tracking application 102 from CMO 106 by download at this time if it is not already installed on the system.

At step 412, recipient application 204 sends its results back to CMO 106, while at step 414, client tracking application 202 sends its generated usage data back to CMO 106 to permit the latter to track usage for the donor system 102 for the various recipient applications 204 being run. Although steps 412 and 414 are shown as discrete steps in the overall flow, in actual practice they would be performed almost continuously in the background as long as one or more recipient applications 204 are running on the donor system 102. At step 416, CMO 106 forwards the results back to the recipient system 104 from which the application 204 originated. CMO 106 may send the results back to the recipient system 104 as it receives them from a donor system 102 or, alternatively, may aggregate results from multiple donors 102 or over a longer time interval before sending them back to the recipient system 104.

Finally, at step 418, CMO 106 generates a tax receipt for a donor system 102 documenting the donation of computing resources in a form acceptable to the Internal Revenue Service or other tax authority. This may be performed either in response to a request from the donor system 102 or upon the occurrence of a specified event, such as the completion of a fiscal year or other tax reporting period. Although not shown on FIG. 4, ultimately the donor uses the tax receipt to document its entitlement to a deduction or other favorable tax treatment being claimed.

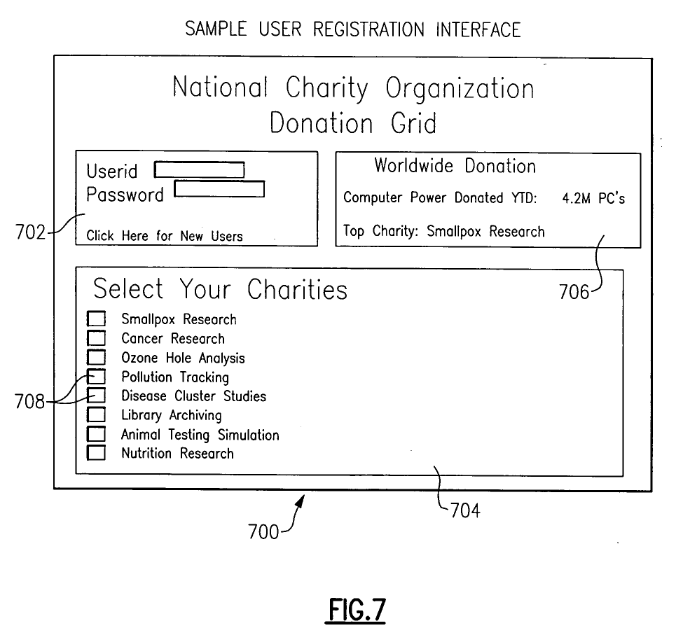

FIG. 5 depicts the data flow of FIG. 4 from the standpoint of a resource donor 102. Thus, referring to FIG. 5, a resource donor 102 first registers with the CMO 106 (step 502), then obtains a list of eligible recipient organizations 104 from the CMO (step 504), then selects one or more of these organizations to which it wants to donate computing resources (step 506), then obtains recipient applications 204 for the selected recipients 104 (step 508). After performing these preliminary steps, the resource donor 102 uses the donated computing resources 206 to run the recipient applications 204, generating results for the recipients 104 while, simultaneously, the client tracking application 202 generates usage data (step 510). Both the application results and the usage data are sent back to the CMO 106 as they are generated (step 512). Finally, either in response to its own request or at the end of a reporting period, the resource donor 102 obtains a receipt from the CMO 106 documenting its donation of computing resources to the various recipient organizations 104 (step 514).

Certain of the steps performed on the donor system 102 would typically be performed with the active involvement of the human user, while certain other steps would typically be performed in the background, without the active involvement or possibly even the conscious awareness of the user. Thus, the human user would typically be actively involved in the registration with the CMO (step 502), as well as the selection of recipient organizations (step 506). On the other hand, such steps as obtaining or refreshing a recipient list (step 504), running the recipient applications 204 (step 510), and sending data back to the CMO 106 (step 512) would typically be performed as background operations.

The steps shown in FIG. 5 need not be performed in the linear sequence shown in that figure. Thus, after obtaining an initial list of recipient organizations (step 504) or making a selection from among them (step 506), a particular donor system 102 may at any later time obtain an updated recipient list or change its selection of recipients (by adding recipients, deleting recipients, etc.).

FIG. 6 depicts the same data flow from the standpoint of the CMO 106. Preliminarily, CMO 106 obtains an application 204 (including code and a work specification) from each participating recipient system 104 (step 602). The CMO 106 then processes donor registrations (step 604), sends recipient lists (step 606), receives recipient selections (step 608), and transmits recipient applications 204 (step 610) as requested by participating donors 102. Continually thereafter, the CMO 106 receives application results and usage data from donors 102, storing the usage data while forwarding the results on to the originating recipient systems (step 612). Finally, either at the end of a reporting period or upon the request of a donor, CMO 106 generates a tax receipt and forwards it to the donor system 102 (step 614).

FIG. 7 shows a sample user interface 700 for use in steps 406 and 410, in which an individual donor registers with CMO 106 and selects recipients 104. Referring to the figure, the user interface 700 would typically appear as part of a window on the user's screen, either in an HTTP client (i.e., a Web browser) or some other application; typically, user interface 700 would be part of the tracking application 202. User interface 700 contains a login portion 702, a selection portion 704, and a status portion 706. Login portion 702 is used to log in to a session with CMO 106 by entering a user ID and password. The user logs in to register and track activity. The client tracking application 202 can also log in transparently in the background to provide resource tracking. Selection portion 704 is used to select a recipient 104 for receiving computing resources 206 by checking one or more boxes 708. (Optionally, there may be additional screens for selecting the type and amount of resources being donated and the like.) Finally, status portion 706 presents selected statistical information, such as (in this particular case) the top charity for this client and (using aggregated usage information obtained from CMO 106) the computing power donated worldwide year to date for the selected charities.

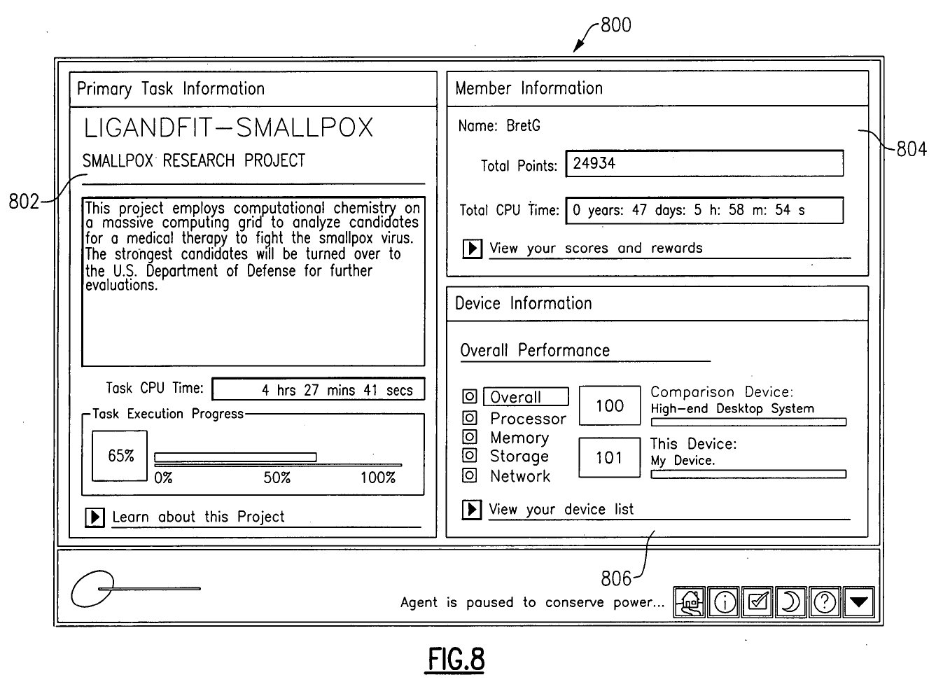

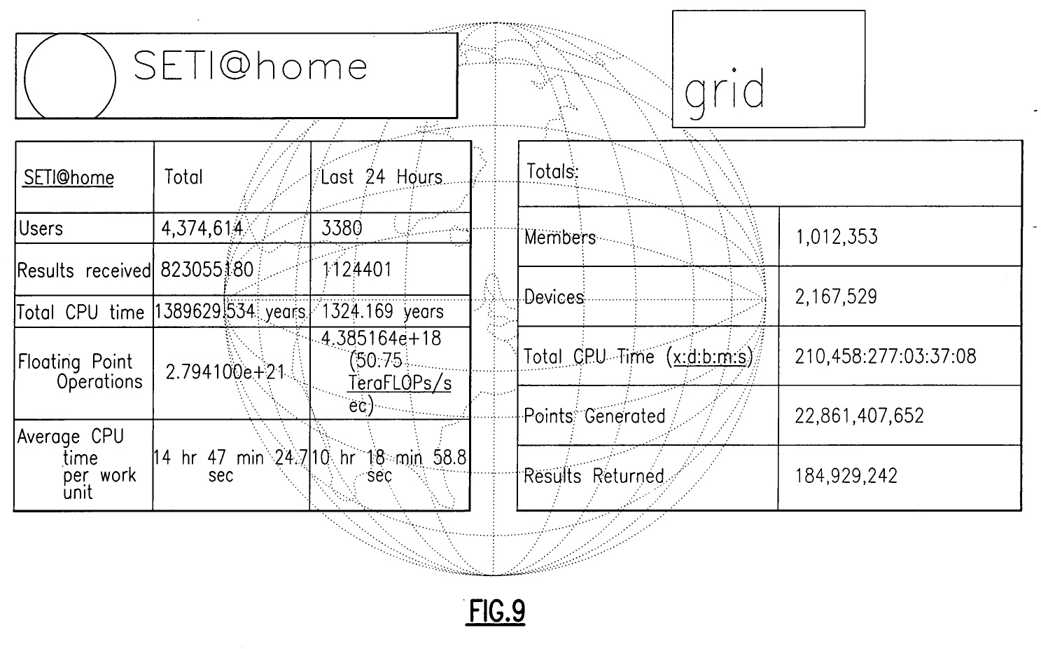

FIG. 8 shows an exemplary view 800 indicating the usage tracking performed by the client tracking application 202 on the donor system 102. As with the user interface 700, the view 800 would typically appear as all or part of a window on the user's screen. Although the invention is not limited to any particular client tracking application 202, in this particular example the tracking application is one provided by United Devices. View 800 contains a primary task information area 802, a member information area 804, and a device information area 806.

Primary task information area 802 identifies the primary task (“LIGANDFIT-SMALLPOX” from the Smallpox Research Project) and indicates the total contributed CPU time the task has spent so far running on the donor system 102 (in this case, 4 hours, 27 minutes and 41 seconds). Primary task information area 802 also indicates the completion state of the task running on the donor system (in this case, 65% complete).

Member information area identifies the individual user (“BretG”) who owns the donor system 102, as well as the total “points” credited to the user so far and total CPU time spent running work for charitable recipients 104. The “points” here are a unit of measure determined by the provider of the service. They can be simple CPU minutes or, alternatively, a standard unit that weights CPU minutes according to the capacity of the CPU so that newer PCs generate a greater computing contribution per CPU minute, commensurate with their greater computing capacity. These units of measure exist today in PC-based grid solutions. While there is no industry standard for this yet, at least one server vendor, Sun Microsystems, has recently introduced a unit of measure for its on-demand server delivery models. In the example shown in FIG. 8, the donor system 102 has contributed 47 days, 5 hours, 58 minutes, and 54 seconds, or 47.249 days, of CPU time to the Smallpox Research Project. If this level of contribution occurred over an actual period of 50 days, then the level of contribution from this system for this period is: 47.249/50=94.5% of the total capacity of the donor system.

Finally, device information area 806 displays information on the various devices on the donor system 102. It would show the capacity and usage of various aspects of the donor system 102 that might be part of the donated capacity (CPU usage, storage, network bandwidth, etc.).

While a particular embodiment has been shown and described, various modifications and extensions of the embodiment disclosed herein, yet within the scope of the invention as claimed herein, will be apparent to those skilled in the art.

What is claimed is:

1. A method for documenting for tax purposes a contribution of a remotely accessed computing resource on a donor system that is allocated by an owner of the resource to a recipient organization, comprising the steps of:
recording usage of the allocated computing resource on the donor system by the recipient organization; and
generating a tax receipt documenting the recorded usage of the allocated computing resource on the donor system by the recipient organization.

2. The method of claim 1, further comprising the step of:
receiving a selection by the owner of the resource of a recipient organization to which to allocate the computing resource.

3. The method of claim 2, further comprising the step of:
transmitting to the donor system work of the selected recipient organization to be performed on the donor system using the allocated computing resource.

4. The method of claim 3, further comprising the step of:
receiving results of the work from the donor system.

5. The method of claim 4, further comprising the step of:
forwarding the received results to the recipient organization.

6. The method of claim 1 in which the recording and generating steps are performed by an entity that is separate from the owner of the computing resource.

7. The method of claim 1 in which the recording and generating steps are performed remotely from the computing resource.

8. The method of claim 1 in which the recording and generating steps are performed remotely from the computing resource by an entity that is separate from the owner of the computing resource.

9. The method of claim 1 in which computing resources on the donor system are allocated to a plurality of recipient organizations and in which the recording and generating steps are performed for each of the plurality of recipient organizations.

10. The method of claim 1 in which the remotely accessed computing resource comprises a central processing unit.

11. A program storage device readable by a machine, tangibly embodying a program of instructions executable by the machine to perform the method steps of claim 1.

12. The program storage device of claim 11 in which computing resources on the donor system are allocated to a plurality of recipient organizations and in which the recording and generating steps are performed for each of the plurality of recipient organizations.

13. A method for deploying computing infrastructure for documenting for tax purposes a contribution of a remotely accessed computing resource on a donor system that is allocated by an owner of the resource to a recipient organization, comprising integrating computer-readable code into a computing system, wherein the code in combination with the computing system is capable of performing the following:
recording usage of the allocated computing resource on the donor system by the recipient organization; and
generating a tax receipt documenting the recorded usage of the allocated computing resource on the donor system by the recipient organization.

14. The method of claim 13 in which computing resources on the donor system are allocated to a plurality of recipient organizations and in which the recording and generating steps are performed for each of the plurality of recipient organizations.

15. Apparatus for documenting for tax purposes a contribution of a remotely accessed computing resource on a donor system that is allocated by an owner of the resource to a recipient organization, comprising:
means for recording usage of the allocated computing resource on the donor system by the recipient organization; and
means for generating a tax receipt documenting the recorded usage of the allocated computing resource on the donor system by the recipient organization.

16. The apparatus of claim 15, further comprising:
means for receiving a selection by the owner of the resource of a recipient organization to which to allocate the computing resource; and
means for transmitting to the donor system work of the selected recipient organization to be performed on the donor system using the allocated computing resource.

17. The apparatus of claim 16, further comprising:
means for receiving results of the work from the donor system and for forwarding the results to the recipient organization.

18. The apparatus of claim 15 in which computing resources on the donor system are allocated to a plurality of recipient organizations and in which the usage is recorded and the recorded usage documented for each of the plurality of recipient organizations.

19. A method for allocating remotely accessed computing resources on a donor system for use by recipient organizations, comprising the steps of:
receiving a selection by the donor system of a plurality of recipient organizations to which to allocate the computing resources;
transmitting to the donor system work of the selected recipient organizations to be performed on the donor system using the allocated computing resources;
receiving results of the work from the donor system; and
forwarding the received results to the recipient organizations.

20. The method of claim 19, further comprising the step of:
recording usage of the allocated computing resource on the donor system by the recipient organizations.

21. A program storage device readable by a machine, tangibly embodying a program of instructions executable by the machine to perform the method steps of claim 19.

22. A method for deploying computing infrastructure for allocating remotely accessed computing resources on a donor system for use by recipient organizations, comprising integrating computer-readable code into a computing system, wherein the code in combination with the computing system is capable of performing the following:
receiving a selection by the donor system of a plurality of recipient organizations to which to allocate the computing resources;
transmitting to the donor system work of the selected recipient organizations to be performed on the donor system using the allocated computing resources;
receiving results of the work from the donor system; and
forwarding the received results to the recipient organizations.

23. Apparatus for allocating remotely accessed computing resources on a donor system for use by recipient organizations, comprising:
means for receiving a selection by the donor system of a plurality of recipient organizations to which to allocate the computing resources;
means for transmitting to the donor system work of the selected recipient organizations to be performed on the donor system using the allocated computing resources;
means for receiving results of the work from the donor system; and
means for forwarding the received results to the recipient organizations.
